(19) United States
(12) Patent Application Publication
(10) Pub. No.: US 2006/0171058 A1
(43) Pub. Date: Aug. 3, 2006

(54) Method to control spiral start point during ammonite servo track writer process using reference servo track band

(75) Inventors: Kwong-Tat Chan, Pleasanton, CA (US); Bipinchandra V. Gami, Northridge, CA (US); Nikolay Ivanov, San Jose, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd.

(21) Appl. No.: 11/049,763

(22) Filed: Feb. 2, 2005

(51) Int. Cl. G11B 21/02

(52) U.S. Cl. 360/75

(57) ABSTRACT

a method for writing servo information onto a disk of a hard disk drive with a servo writer. The method includes writing a reference servo pattern onto a track of a disk. A head is then positioned relative to the reference servo pattern and a spiral servo track is written onto the disk. The process of positioning the head relative to the reference servo pattern and writing a spiral servo track can be repeated to create a plurality of spiral servo tracks on the disk. The spiral tracks are used to write radial servo patterns that are utilized during normal operation of the drive. The reference servo pattern allows each spiral track to start at a point with the same radial distance from the center of the disk. This improves the accuracy of the spiral tracks and the resultant final servo patterns.

### BACKGROUND OF THE INVENTION

1. Field of the Invention

The present invention relates to a method for writing servo onto disks of a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

Information is typically stored in radial tracks that extend across the surface of each disk. Each track is typically divided into a number of segments or sectors. The voice coil motor and actuator arm can move the heads to different tracks of the disks.

FIG. 1 shows a typical track that has a number of fields associated with each sector. A sector may include an automatic gain control (“AGC”) field 1 that is used to adjust the strength of the read signal, a sync field 2 to establish a timing reference for the circuits of the drive, and ID 3 and Gray Code 4 fields to provide sector and track identification.

Each sector may have also a servo field 5 located adjacent to a data field 6. The servo field 5 contains a plurality of servo bits A, B, C and D that are read and used to position the head 7 relative to the track.

The fields 1-5 must be written onto the disk surfaces during the manufacturing process of the disk drive. These fields are typically written with a servo writer. The servo tracks are sometimes written using a number of spiral servo tracks initially written onto the disks. FIG. 2 shows an example of a number of spiral servo tracks written onto a disk. Using spiral servo tracks is sometimes referred to as an Ammonite servo write process. The spiral servo tracks are used to write the final radial servo tracks that are utilized during the normal operation of the disk drive.

As shown in FIG. 2, the radial start point of each spiral track may vary because of system vibration, servo track writer positioning errors and other factors. The variation of the start points will vary the location of the spiral track and ultimately create inaccuracies in the final servo pattern. Inaccurate servo can lower the density and degrade the performance of the drive. It would be desirable to improve the accuracy of spiral servo tracks used to write radial servo patterns.

### BRIEF SUMMARY OF THE INVENTION

A method for writing servo onto a disk of a hard disk drive. The method includes writing a reference servo pattern onto a track of a disk. A head is positioned relative to the reference servo pattern and a spiral servo track is then written onto the disk.

### BRIEF DESCRIPTION OF THE DRAWINGS

FIG. 1 is an illustration of a track of the prior art;

FIG. 2 is an illustration showing a plurality of spiral servo tracks written onto a disk in the prior art;

FIG. 3 is a top view of an embodiment of a hard disk drive;

FIG. 4 is a top enlarged view of a head of the hard disk drive;

FIG. 5 is a schematic of an electrical circuit for the hard disk drive;

FIG. 6 is a schematic showing a servo writer connected to the hard disk drive;

FIG. 7 is a flowchart describing a process to write a servo pattern onto a disk of the drive;

FIG. 8 is an illustration depicting the movement of a head during the writing of a spiral track;

FIG. 9 is an illustration showing a plurality of spiral servo tracks written onto the disk.

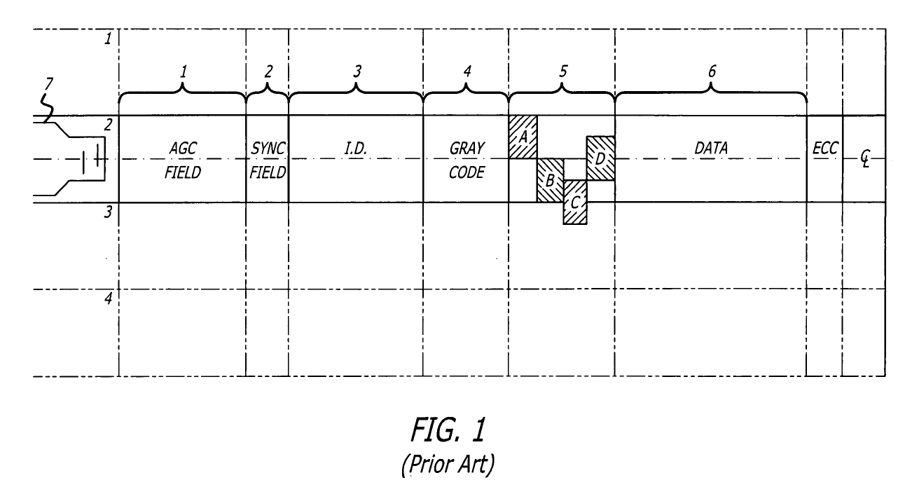

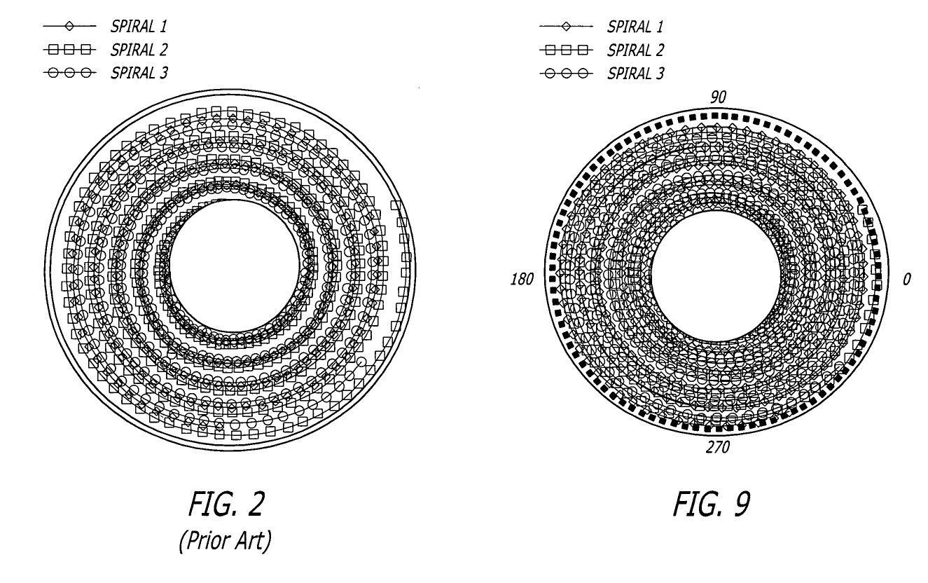

### DETAILED DESCRIPTION

Disclosed is a method for writing servo information onto a disk of a hard disk drive with a servo writer. The method includes writing a reference servo pattern onto a track of a disk. A head is then positioned relative to the reference servo pattern and a spiral servo track is written onto the disk. The process of positioning the head relative to the reference servo pattern and writing a spiral servo track can be repeated to create a plurality of spiral servo tracks on the disk. The spiral tracks are used to write radial servo patterns that are utilized during normal operation of the drive. The reference servo pattern allows each spiral track to start at a point with the same radial distance from the center of the disk. This improves the accuracy of the spiral tracks and the resultant final servo patterns.

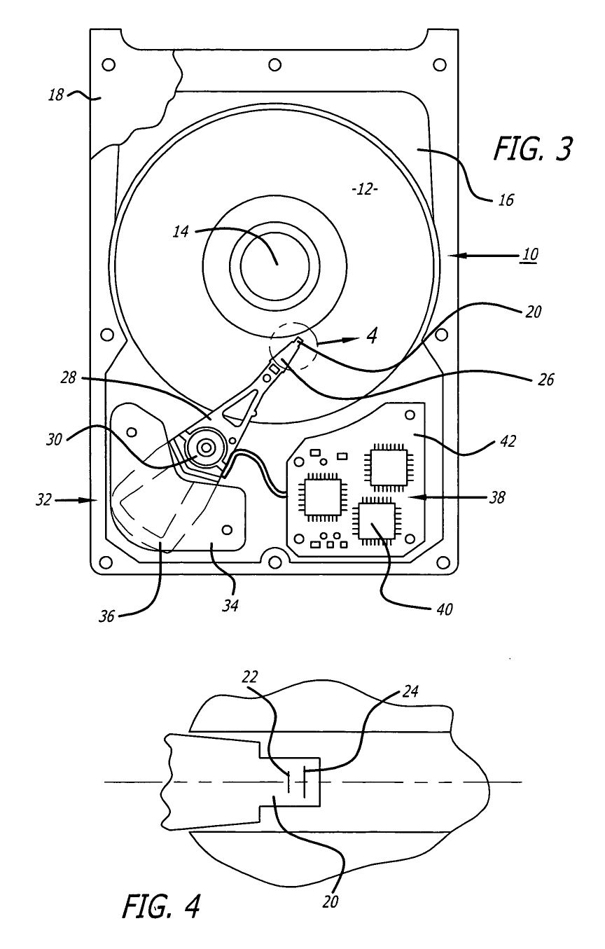

Referring to the drawings more particularly by reference numbers, FIG. 3 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. As shown in FIG. 4 the heads 20 may have separate write 22 and read elements 24. The write element 22 magnetizes the disk 12 to write data. The read element 24 senses the magnetic fields of the disks 12 to read data. By way of example, the read element 24 may be constructed from a magneto-resistive material that has a resistance which varies linearly with changes in magnetic flux.

Referring to FIG. 3, each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

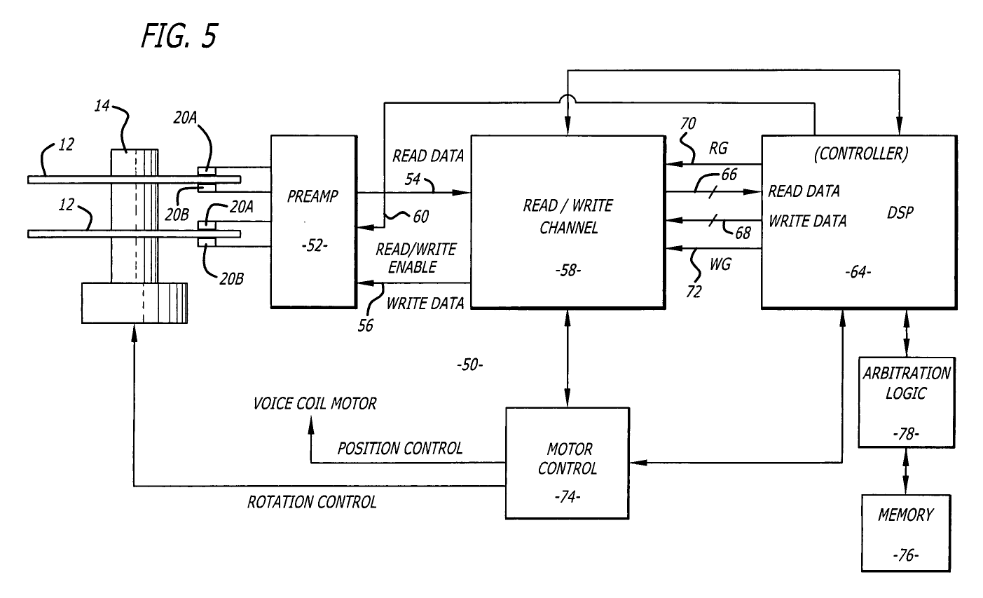

FIG. 5 shows an electrical circuit 50 for reading and writing data onto the disks 12. The circuit 50 may include a pre-amplifier circuit 52 that is coupled to the heads 20. Each disk 12 may included a first head 20A and a second head 20B. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 62 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 62 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”) that contains instructions that are read by the controller 64. The memory 76 may be coupled to the controller 64 by arbitration logic 78.

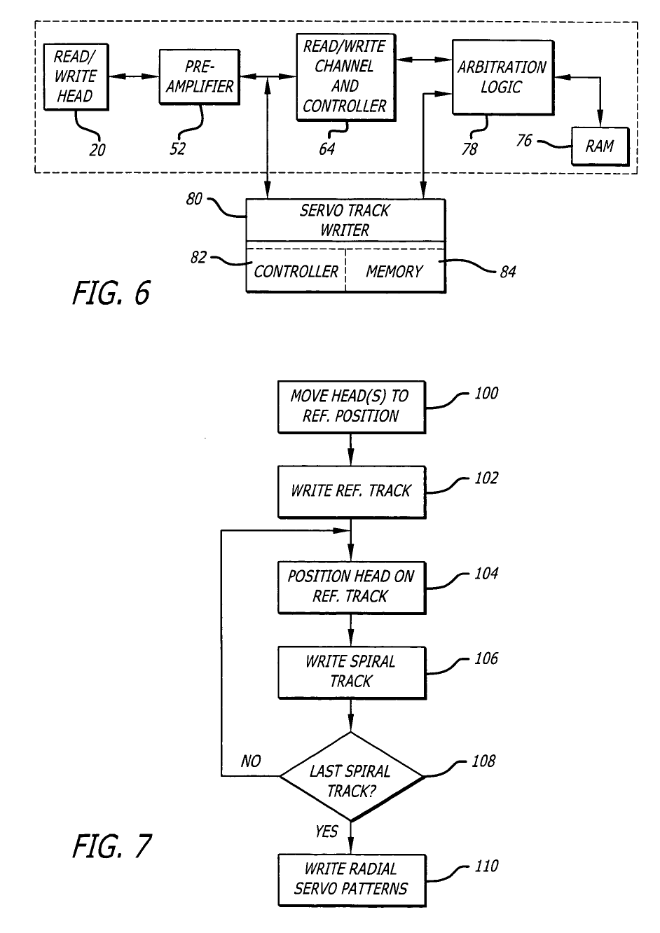

During the manufacturing process of the disk drive 10 servo information must be written onto the disks 12. This is typically done with a servo track writer 80. FIG. 6 shows a servo track writer 80 connected to a hard disk drive 10. The servo track writer 80 may include a controller 82, memory 84 and other circuitry for writing servo information onto the disk(s) of the disk drive. The servo writer 80 may utilize the pre-amplifier, read/write channel, etc. of the disk drive to both write servo information, and to read servo information to position a head onto a track of the disk(s).

FIG. 7 is a flowchart describing the writing of reference information onto the disk(s) with the servo track writer. In block 100 the head(s) of the drive is initially moved to a reference position. The reference position may be at the outer diameter, or the inner diameter, of the disk. The reference position may be established by the crash stop location of the drive. In block 102 a reference servo pattern is written at the reference radial position. A plurality of servo patterns may be written to create a reference track. Additionally, several servo tracks may be written to create a band of reference servo tracks. The creation of the reference servo information can be caused by the controller of the servo track writer.

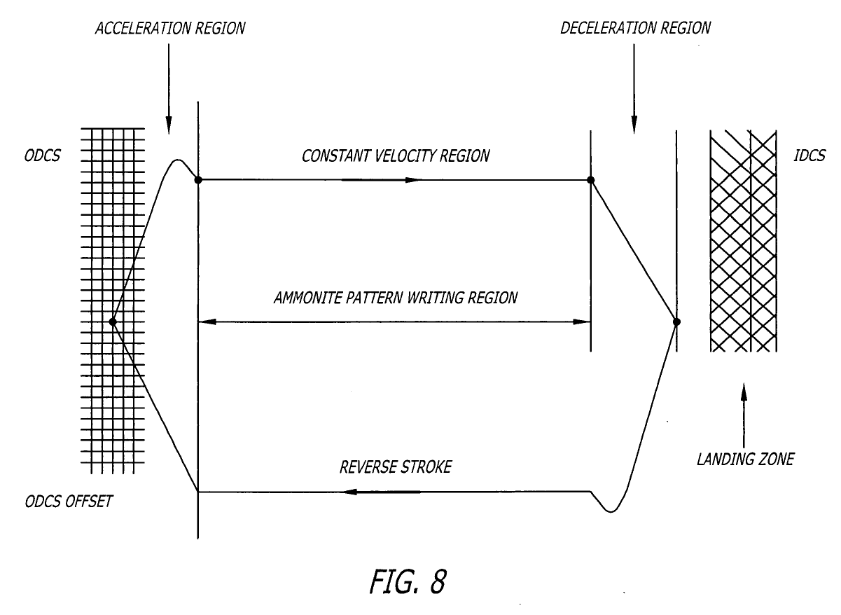

In block 104 the head(s) is positioned relative to the reference servo pattern, reference track, or band. The controller of the servo track writer may utilize the servo capabilities of the disk drive to position the head(s). Once the head is positioned, the servo writer causes a spiral servo track to be written onto the disk(s) in block 106. As shown in FIG. 8 the spiral tracks may be written by initially accelerating the heads, moving the heads at a constant velocity, and then decelerating the heads. Referring to FIG. 7, the servo track writer controller then determines whether the last spiral servo track has been written in process block 108. If not, the head is again positioned relative to the reference servo pattern and another spiral servo track is written onto the disk(s).

If the last spiral servo track has been written, then the servo writer writes radial servo tracks using the spiral servo track for positioning information in block 110. The radial servo tracks are used to position the heads during the normal operation of the drive.

As shown in FIG. 9, the process may create a plurality of spiral servo tracks that each have a start point with the same radial distance relative to the center of the disk. The utilization of a reference track improves the accuracy of the spiral tracks and the resultant radial servo tracks used by the drive. An increase in the accuracy of the servo information may lead to an increase in the density of the drive.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for writing servo information onto a disk of a hard disk drive, comprising:
writing a reference servo pattern onto a track of a disk;
positioning a head of the hard disk drive relative to the reference servo pattern; and,
writing a first spiral servo track onto the disk.

2. The method of claim 1, further comprising repositioning the head relative to the reference servo pattern and writing a second spiral servo track onto the disk.

3. The method of claim 2, further comprising repositioning the head relative to the reference servo pattern and writing a third spiral servo track onto the disk.

4. The method of claim 1, wherein a band of reference servo tracks are written onto the disk.

5. The method of claim 1, wherein the reference servo pattern is located at an outer diameter of the disk.

6. The method of claim 1, wherein the head has a period of acceleration, a period of constant velocity and a period of deceleration during the writing of the first spiral servo track.

7. The method of claim 6, further comprising using the first spiral servo track to write radial servo information onto the disk.

8. A servo writer that writes servo information onto a disk of a hard disk drive, comprising:
a controller that causes the writing of a reference servo pattern onto a track of a disk, the positioning of a head of the hard disk drive relative to the reference servo pattern, and the writing of a first spiral servo track onto the disk.

9. The servo writer of claim 8, wherein said controller causes a repositioning of the head relative to the reference servo pattern and the writing of a second spiral servo track onto the disk.

10. The servo writer of claim 8, wherein said controller causes the repositioning of the head relative to the reference servo pattern and the writing of a third spiral servo track onto the disk.

11. The servo writer of claim 8, wherein a band of reference servo tracks are written onto the disk.

12. The servo writer of claim 8, wherein the reference servo pattern is located at an outer diameter of the disk.

13. The servo writer of claim 8, wherein the head has a period of acceleration, a period of constant velocity and a period of deceleration during the writing of the first spiral servo track.

14. The servo writer of claim 7, wherein said controller utilizes the first spiral servo track to cause the writing of radial servo information onto the disk.
